(19) United States
(12) Patent Application Publication
(10) Pub. No.: US 2006/0285215 A1
(43) Pub. Date: Dec. 21, 2006

(54) Printing method for making a lenticular lens material

(75) Inventor: Teh Ming Wu, Shanghai (CN)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: INX International Ink Co., Schaumburg, IL (US)

(21) Appl. No.: 11/450,203

(22) Filed: Jun. 9, 2006

(30) Foreign Application Priority Data
Jun. 9, 2005 (CN) 200510026583.6

(51) Int. Cl. G02B 27/10

(52) U.S. Cl. 359/619

(57) ABSTRACT

The invention generally provides a method for making a lenticular lens material using energy-curable inks and energy-curable coatings, for example, UV-curable inks and coatings, having differential surface tensions or different surface energies. The steps of the method include: (a) providing a transparent substrate sheet having a front and a back; (b) printing an array of substantially parallel lines in at least one energy-curable ink on the front of the sheet; (c) applying at least one energy-curable coating over the array printed in energy-curable ink, the ink and coating being chosen so that sufficient repulsion is created on contact between the ink and the coating to form an aligned series of contiguous beads of coating material before curing takes over to ensure the formation of a lenticular lens structure over the image printed in energy-curable ink; and (d) curing to produce a stable lenticular lens structure.

### CROSS-REFERENCE TO RELATED PATENT APPLICATIONS

This application claims the benefit of Chinese Patent Application No. 200510026583.6, filed Jun. 9, 2005.

### FIELD OF THE INVENTION

The present invention relates to a method for printing, and in particular to a method for creating a lens material using energy-curable inks and energy-curable coatings, for example, UV-curable inks and coatings. This lens is used to create images with a three dimensional appearance, or an image often referred as lenticular. The energy-curable inks can be applied using various printing techniques including conventional or waterless offset printing, online or off-line, as well as ink-jet printing.

### BACKGROUND OF THE INVENTION

Lenticular lens material generally comprises a transparent substrate or web that has on its top surface an array of substantially parallel refractive optical ridges (i.e., lenticules) that are arranged side-by-side. Lenticular lens material is used in conjunction with lenticular images comprising generally parallel strips of interlaced images disposed behind the lenticular lens material. Various visual effects can be achieved using lenticular lens material and lenticular images including motion effects and 3-D effects.

Currently, there are two methods commonly used in the printing arts to produce lenticular lens material. In one method, substrates can be coated with curable resins using silk screen printing or flexographic printing. However, silk screen printing lacks fineness and can be difficult to apply in many directions. In addition, in these and other known types of printing processes, registration of the interlaced, lenticular images is less than ideal and produces poor image quality. In another known method, lenticular material is extruded in situ, or pre-extruded lenticular sheets are employed, combined with printing of images on the opposite side of the transparent web, to give the images a stereo effect when light rays pass through the lenticular material and the refractive transparent web. However, extruded materials are expensive and in the extruded materials the lenticular surface only runs in one direction. An additional problem is that when used in boxes and packages these extruded materials are difficult to fold.

Chinese Patent Publication No. 1586900 to Wu discloses an off-line spot glossing method in which a UV-curable ink is used in combination with a varnish to produce a contrasting non-glossy/glossy areas. Lenticular lenses are not formed by this method.

In the past, printers avoided overlaying inks with differential surface tensions, because if these differential surface tension inks were overlaid, the possibility for random surface defects increased. Such defects, including, for example, pin-holing, crawling, and orange peeling, result in an undesirable printed product with a rough lay and poor or uneven gloss.

If a way could be found to produce a finer lenticular lens material with increased resolution, registration with the interlaced lenticular images could be improved. In addition, if a way could be found to produce a finer lenticular lens material by a printing process, this would represent a useful contribution to the art. The use of offset printing and coating using a particular combination of energy-curable inks and energy-curable coatings, which eliminates the shortcomings of known silk screening and flexographic printing techniques, would also represent a useful contribution to the art.

### BRIEF SUMMARY OF THE INVENTION

In one embodiment, the invention provides a method for creating a lenticular lens-like material comprising: (a) providing a transparent substrate sheet having a front and a back, (b) printing a lenticular image on the back of the sheet, (c) curing the printed image, (d) printing in at least one energy-curable ink at least one array of substantially parallel lines on the front of the sheet, (e) applying at least one energy-curable coating of a higher surface tension than the ink over the printed array so that the energy-curable coating forms a corresponding array of substantially parallel optical ridges comprising a lenticular lens structure, and (f) curing the lenticular lens structure. Steps (d) or (e) can be carried out online or, optionally, off-line. In alternate embodiments, steps (b) and (c) can be carried out after the formation of the lenticular lens structure or the lenticular image can be printed on a separate sheet that is affixed to the back of the transparent substrate.

In another embodiment the invention provides a surface tension formed lenticular lens material comprising a transparent substrate sheet having a front and a back; a first printed image on the back of the sheet; and at least one array of substantially parallel optical ridges comprising a lenticular lens structure on the front of the sheet, the lenticular lens structure comprising a combination of at least one energy-curable ink and at least one energy-curable coating, the energy-curable coating having a surface tension greater than the surface tension of the energy-curable ink.

### BRIEF DESCRIPTION OF THE DRAWINGS

FIG. 1 illustrates a cross sectional view of a lenticular lens material made according to an embodiment of the present invention.

FIG. 2 is a perspective structural view of another embodiment of the lenticular lens material.

FIG. 3 is a process flow diagram that illustrates a method for creating a lenticular lens material according to an embodiment of the present invention.

### DETAILED DESCRIPTION OF THE INVENTION

According to an embodiment of the present invention, a novel lenticular lens material is prepared using a manufacturing process that combines offset printing and coating technologies. Conventional and waterless offset printing techniques may be used, as well as ink-jet printing techniques. It has now been unexpectedly found that a combination of an array of substantially parallel lines comprising at least one energy-curable ink applied by offset printing or by inkjet printing, and at least one energy-curable coating over the printed lines provides a corresponding array of substantially parallel optical ridges comprising a lenticular lens structure of sufficient fineness to provide excellent image resolution, and also avoids defects in the product.

In the embodiments of the present invention, the term “energy curing” means curing or drying by means of an energy source, such as, but not limited to, UV light or energy, electron beam (EB), or light-emitting diode (LED), or any other high energy light source. A useful energy source is one that will polymerize a monomer to a polymer. The term “energy-curable,” when used in this disclosure, refers to a material or substance, such as, for example, a chemical resin, ink, or coating, which will be cured using the energy sources listed above.

In another embodiment of the invention, a method has been discovered to prepare a lenticular lens material. This method is carried out by printing an appropriate lens image on the back of a transparent plastic substrate sheet. At a specific, designated position (or multiple positions) on the top layer of the plastic substrate, an array of substantially parallel lines oriented generally parallel to the image strips making up the lenticular image is printed in an energy-curable ink, and then an energy-curable coating is applied over the array(s) of lines. Mutual exclusion due to a difference in surface tension/surface energy between the energy-curable coating and the energy-curable ink causes the coating to bead up forming a series of beads of coating material aligned along the substantially parallel inked lines below. These aligned series of beads serve as optical ridges or lenticules to provide an effective and inexpensive lenticular lens material. By this method, 1) illustrations, including at least portions lined to produce a 3-D, moving effect when viewed through a lenticular lens, are printed on the back of the substrate first, 2) a particular energy-curable ink is applied as an array of substantially parallel lines on at least the corresponding area on the front of the transparent substrate, and then 3) a coating is overprinted on the non-lenticular area or over the entire front area.

The choice of inks and coatings to produce aligned series of beads as described above requires either: (1) the choice of inks that when still uncured have a surface tension lower than the coatings when still uncured or (2) the choice of inks that, after curing, have a surface energy lower than the coatings after curing. This difference in surface tension or surface energy between the energy-curable ink and the energy-curable coating produces repulsion or mutual exclusion, forming a beaded lenticular lens line structure as described earlier and results in a unique lenticular end product.

As noted above, the surface tension of the energy-curable coating must be greater than the surface tension (or surface energy) of the energy-curable ink. This may be achieved by way of introducing siloxanes, or silicone surfactants, in the energy-curable ink. For example, preferred surface tension/surface energy of a cured UV-curable coating is from about 43 dynes/cm to about 58 dynes/cm, and a corresponding preferred surface tension/surface energy of a cured UV-curable ink is from about 28 dynes/cm to about 33 dynes/cm. A particularly preferred surface tension/surface energy of a cured UV-curable coating is from about 54 dynes/cm to about 58 dynes/cm, for example in a UV-curable epoxy coating. The surface tension/surface energy of the UV-curable epoxy coating can be at least twice the surface tension of the UV-curable ink. In practice, a differential in surface tension/surface energy of at least 10 dynes/cm should be maintained and preferably a differential of at least 15 dynes/cm will be achieved. These differentials may be achieved by making appropriate choices of available inks and coating compositions.

The lenticular lens material of the invention can be used in many applications including in packaging with printed surfaces, in plastic products, and for forgery prevention. Since the present process permits arrays of lenticules to be oriented in different ways on a single sheet, packaging made from a single sheet with lenticular images on two or more sides of the assembled package may be made in accordance with the present invention.

In contrast with existing technologies, the invention uses the offset printing, thus producing a more precise lenticular effect than available with many existing technologies. It should be noted that registration of the printed image is not considered critical in the present invention so long as the lines of the lenticular lens material and the lenticular image are generally aligned. Also, while the lenticular image is described above as being printed on the back of the transparent substrate, in a less desirable alternative the image may be printed on a separate sheet and then applied to the back of lenticular lens material otherwise produced as described above.

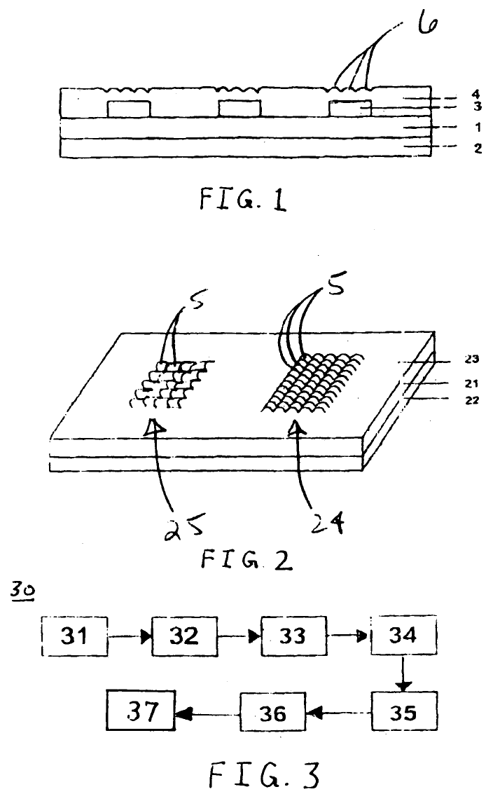

Now referring to FIG. 1, a plastic substrate 1 is printed with an image layer 2 by known methods on the back of the plastic substrate 1 or an image 2 or illustration is combined with or adhered to the plastic substrate 1 by known methods. An array of substantially parallel lines is printed from an energy-curable ink 3 over the entire top surface of the substrate, or at designated locations, on the top of substrate 1. An energy-curable coating 4 is next applied over the entire area, or over portions of the substrate surface at the designated locations. The difference in surface tension between the energy-curable coating 4 and the energy-curable ink 3 causes a series of contiguous beads 5 to produce optical ridges 6 along the substantially parallel inked lines below. Thus, a lenticular lens structure 5 is formed directly over the image printed in energy-curable ink 3. The thicknesses of these optical ridges or lenticules can range from about 1 micron to about 20 microns; preferably the thicknesses will range from about 2 microns to about 10 microns; and, most preferably the thicknesses will range from about 5 microns to about 10 microns. Thus, using these printing techniques, certain types of lenticular visual effects can be achieved, such as, for example, 3-dimensional (3-D) images and moving images.

FIG. 2 shows an alternative view of the product. In this view, a transparent plastic substrate 21 includes an image layer 22, and a lenticular lens layer 23. It is clear from this figure that the form of the lenticular lens layer 23 can be varied. For example the orientation and direction of the lenticular lens structure can be varied as shown by producing the two arrays of lenticules 24 and 25 with lenticules oriented at 90° to each other. These and other diverse multi-directional lenticular effects can be achieved with the present invention.

FIG. 3 is a process flow diagram that illustrates a method 30 for manufacturing the lenticular lens material. First, a transparent substrate is obtained or provided in step 31. A lenticular image is printed on the back of the substrate in step 32. Next, the printed image is cured or dried in step 33. The energy-curable ink is printed offline or online on the front surface of the substrate in designated positions as described above in step 34. This is followed by application of energy-curable coating, applied off-line or online over designated areas (that is, over the printed areas on the front surface) or over the entire area as in step 35. The energy-curable ink and the energy-curable coating form a lenticular lens structure on the front surface of the substrate in step 36, as described above. After curing, the resulting product is ready for use in step 37.

Useful transparent substrates include plastics, such as polyester, polyethylene, polypropylene, vinyl, polyethylene terephthalate, polystyrene, poly(methyl methacrylate), and the like, and mixtures thereof. Other appropriate transparent materials can be employed, such as polycarbonate. Particularly preferred materials for substrates are polyester and polycarbonate.

The energy-curable inks according to the present invention can include a resin, at least one monomer, a varnish, at least one photoinitiator, and at least one stabilizer, and a siloxane, and optionally, a hybrid UV ink vehicle. A useful resin is polyester resin, sold as CN293 polyester acrylate, available from Sartomer (Exton, Pa.), and the like. Monomers that are used in the energy-curable inks include, but are not limited to, SR351H TMPTA monomer (Trimethyol propane triacrylate), available from Sartomer; DiTMPTA Monomer (Di-Trimethyol propane triacrylate), available from Rahn USA (Aurora, Ill.); EB (Ebecryl) 3700 bisphenol A epoxy acrylate, available from Cytec (Smyrna, Ga.), and the like. A useful varnish includes a 50:50 wt./wt. blend of sucrose benzoate and TMPTA monomer. Useful stabilizers, for example, UV stabilizers, include, but are not limited to, IRGANOX 1076 UV stabilizer, available from Ciba Specialty Chemicals (Tarrytown, N.Y.); tert-Butylhydroquinone (TBHQ), available from Chempoint (Chicago, Ill.), and the like. Useful photoinitiators include, but are not limited to, 2-methyl-1-(4-[methylthio]phenyl-2-(4-morpholinyl)-1-propanone, sold as CHIVACURE 107 UV photoinitiator, available from Chitec Chemical Co. (Taipei, Taiwan); 1-hydroxy-cyclohexylphenyl ketone, sold as Esacure KS300, available from Lamberti (Albizzate, Italy); oligo[2-hydroxy-2-methyl-1-[4-(methylvinyl)phenyl]propanone], sold as Esacure One Photoinitiator, available from Lamberti; Irgacure, available from Ciba Specialty Chemicals; benzophenone; BioAccu 907, and the like. A useful hybrid UV ink vehicle is CV1010 Hybrid Ink Vehicle, available from Ink Solutions (Elk Grove Village, Ill.). Fillers such as waxes, clays, and fumed silica can be used in the energy-curable inks. For example, a useful filler is SYLOID amorphous silica, for uexample Syloid LV-6, available from Grace Davison (Baltimore, Md.). Optionally, additives such as antioxidants and anti-misting compounds can also be used.

Siloxanes preferably are used in the energy-curable inks of the present invention. The siloxanes can include silicone surfactants, polydimethylsiloxanes, dimethicones, organo modified polysiloxanes, cyclopentasiloxanes, silicone oils such as methyl silicone oil and dimethyl silicone oil, organofunctional silanes, and the like, and blends or mixtures thereof. The siloxanes can also include copolymers or graft polymers, such as silicone acrylate, silicone polyether acrylate, polyether siloxane copolymer, polysiloxane polyether copolymer, for example. Preferred siloxanes include TEGO Rad 2100, TEGO Rad 2250, TEGO Rad 2500, TEGO Rad 2650, TEGO Rad 2700 (silicone acrylate), TEGO Rad 2100, TEGO Glide 410, TEGO Hammer 30K available from Degussa Goldschmidt, Hopewell, Va., and Essen, Germany); CoatOSil 3573, Silwet L-7602, SF-96; Dow Corning 57; and BYK-UV 3510. The siloxanes have viscosities that range from about 80-2500 mPa·sec at 77° C. TEGO Rad 2700, a preferred siloxane, has a viscosity in a range from about 800-2000 mPa·sec at 77° C.

The energy-curable coating according to the present invention can include a resin, at least one monomer, at least one photoinitiator, and at least one stabilizer, and optionally, at least one additive, for example, an optical brightener, or an organic amine. Useful coating resins include acrylated epoxys, polyester monomers or polyester resins, acrylate resins (for example, dissolved in monomer), inert resins, hydrocarbon resins, acrylic resins, polyketones, sucrose benzoate, and the like. A particularly useful resin is Bis-Phenol Epoxy Acrylate cut in 25% TRPGDA, sold as (EB) Ebecryl 3720-TP25, available from Cytec (Smyrna, Ga.). Monomers that are used in the energy-curable coatings can include, but are not limited to, SR351H TMPTA monomer (Trimethyol propane triacrylate), available from Sartomer (Exton, Pa.); DiTMPTA Monomer (Di-Trimethyol propane triacrylate), available from Rahn USA (Aurora, Ill.); TRPGDA Monomer (Tripropylene glycol diacrylate), available from Sartomer; EB (Ebecryl) 3700 bisphenol A epoxy acrylate, available from Cytec (Smyrna, Ga.), and the like. Useful photoinitiators include, but are not limited to, 2-methyl-1-(4-[methylthio]phenyl-2-(4-morpholinyl)-1-propanone, sold as CHIVACURE 107 UV photoinitiator, available from Chitec Chemical Co. (Taipei, Taiwan); 1-hydroxy-cyclohexylphenyl ketone, sold as Esacure KS300, available from Lamberti (Albizzate, Italy); oligo[2-hydroxy-2-methyl-1-[4-(methylvinyl)phenyl]propanone], sold as Esacure One Photoinitiator, available from Lamberti; Irgacure, available from Ciba Specialty Chemicals; benzophenone; and the like. Useful stabilizers, for example, UV stabilizers, include, but are not limited to, IRGANOX 1076 UV stabilizer, available from Ciba Specialty Chemicals (Tarrytown, N.Y.); tert-Butylhydroquinone (TBHQ), available from Chempoint (Chicago, Ill.), and the like. Additives such as optical brighteners and fillers can be used in the energy-curable coatings. For example, a useful optical brightener is 2,2′-(2,5-thiophenediyl)bis (5-tert-butylbenzoxazole), sold as Benetex OB Plus, available from Mayzo, Inc. (Norcross, Ga.). Amines can be used to abstract protons in photolytic reactions, for example, n-butyldiethanolamine (n-BDEOA), and the like.

It is preferred to omit silicone or siloxane in the energy-curable coatings of the present invention. In all embodiments of the invention, the energy-curable ink component preferably will include a silicone surfactant or siloxane, which confers a low surface tension. The key, however, is that the difference in surface tension between the energy-curable ink and the energy-curable coating is sufficiently great that repulsion is created on contact between the layers formed by the ink and coating, such that the aligned series of beads of coating material are formed before curing takes over, thereby ensuring the formation of a lenticular lens structure.

The following examples further illustrate the invention but, of course, should not be construed as in any way limiting its scope.

### EXAMPLE 1

Sample Energy-Curable Ink Formulation

An exemplary energy-curable ink formulation is shown in Table 1 below. All values in Table 1 are expressed in weight in pounds (lb).

TABLE 1

| Component | Formulation A |
|---|---|
| CN293 Acrylated | 35.00 |
| Polyester | |
| EB3700 Bisphenol A | 14.00 |
| Epoxy Acrylate | |
| Varnish (50:50 wt./wt. | 20.00 |
| sucrose benzoate - | |
| TMPTA monomer¹) | |
| Irganox 1076 UV | 0.25 |
| Stabilizer | |
| SR351H TMPTA¹ | 9.85 |
| monomer | |
| Chivacure 107 UV | 2.20 |
| Photoinitiator | |
| Benzophenone | 5.00 |
| Esacure KS300 | 2.20 |
| Photoinitiator | |
| SYLOID LV6 | 10.00 |
| amorphous silica | |
| TEGO Rad 2700 | 1.50 |
| Total | 100.00 |

¹TMPTA: Trimethyol propane triacrylate

The energy-curable ink formulation (Formulation A) is prepared by mixing the liquid components uniformly, then mixing in the solid components (i.e. silica and stabilizer). Formulation A is then milled in a three-roll mill. This preparative method is standard procedure in the ink industry.

### EXAMPLE 2

Sample Energy-Curable Epoxy Coating Formulation

An exemplary energy-curable coating is an energy-curable epoxy coating formulation, as shown in Table 2 below. All values in Table 1 are expressed in weight in pounds (lb).

TABLE 2

| Component | Formulation B |
|---|---|
| EB3720 TP25 | 32.00 |
| Acrylated Epoxy | |
| Monomer | |
| SR351H TMPTA¹ | 31.20 |
| monomer | |
| SR306 TRPGDA² | 18.40 |
| Irganox 1076 UV | 0.30 |
| Stabilizer | |
| Benetex Optical | 0.10 |
| Brightener Plus Fluor | |
| Benzophenone | 10.00 |
| Esacure KS300 | 3.00 |
| Photoinitiator | |
| n-Butyldiethanolamine | 5.00 |
| Total | 100.00 |

¹TMPTA: Trimethyol propane triacrylate
²TRPGDA: Tripropylene glycol diacrylate

The energy-curable epoxy coating formulation (Formulation B) is prepared by mixing the liquid components uniformly, then mixing in the solid components (i.e. optical brightener and stabilizer). This preparative method is standard procedure in the ink industry.

### EXAMPLE 3

Bead Test Using Dyne Fluids Applied Over UV-Cured Ink

Surface energy/tension readings were made with dyne pens over cured ink. This factor was measured using water/ethylene glycol solutions of different dyne values and monitoring how fast the beading or reticulation of the solution formed on the UV-cured ink surface. For example, for a UV-curable ink prepared according to the present invention, the maximum value of 33 dynes/cm was obtained; whereas, for a UV-curable coating prepared according to the present invention, a minimum of 43 dynes/cm showed a slow response to bead or reticulate. Thus, the minimum surface energy/surface tension difference for the successful formation of the lenticular lens structure was qualitatively determined to be about 10 dynes/cm.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A method for creating a lenticular lens material, comprising the steps of:
(a) providing a transparent substrate sheet having a front and a back;
(b) printing an array of substantially parallel lines in at least one energy-curable ink on the front of the sheet;
(c) applying at least one energy-curable coating over the array printed in energy-curable ink, the ink and coating being chosen so that sufficient repulsion is created on contact between the ink and the coating to form an aligned series of contiguous beads of coating material before curing takes over to ensure the formation of a lenticular lens structure over the image printed in energy-curable ink; and
(d) curing to produce a stable lenticular lens structure.

2. The method of claim 1 including printing an image on the back of the sheet and curing the printed image.

3. The method of claim 1 including printing an image a separate sheet and attaching the printed sheet to the back of the sheet bearing the lenticular image.

4. The method of claim 1, wherein the surface tension of the energy-curable coating is greater than the surface tension of the energy-curable ink, and wherein the difference in the surface tension is at least about 10 dynes/cm.

5. The method of claim 1, including at least two differently oriented lenticular lens structures on the substrate.

6. The method of claim 4, wherein the surface tension of the energy-curable coating is from about 54 dynes/cm to about 58 dynes/cm.

7. The method of claim 4, wherein the surface tension of the energy-curable ink is from about 28 dynes/cm to about 32 dynes/cm.

8. The method of claim 1, wherein the surface tension of the energy-curable coating is at least twice the surface tension of the energy-curable ink.

9. The method of claim 1, wherein the transparent substrate sheet comprises plastic.

10. The method of claim 9, wherein the plastic is selected from the group consisting of polyester, polyethylene, polypropylene, vinyl, polyethylene terephthalate, polystyrene, poly(methyl methacrylate), polycarbonate, and mixtures thereof.

11. The method of claim 1, wherein the aligned series of contiguous beads of coating material have an average thickness from about 1 micron to about 20 microns.

12. The method of claim 1, wherein the aligned series of contiguous beads of coating material have an average thickness from about 5 microns to about 10 microns.

13. A surface tension formed lenticular lens material, made by the method of:
(a) providing a transparent substrate sheet having a front and a back;
(b) printing an array of substantially parallel lines in at least one energy-curable ink on the front of the sheet;
(c) applying at least one energy-curable coating over the array printed in energy-curable ink; and
(d) curing to produce a stable lenticular lens structure,
wherein there is a difference in the surface tensions of the ink and the coating of at least about 10 dynes/cm.

14. The surface tension formed lenticular lens material of claim 13, wherein the surface tension of the cured coating is from about 54 dynes/cm to about 58 dynes/cm.

15. The surface tension formed lenticular lens material of claim 13, wherein the surface tension of the energy-curable ink is from about 28 dynes/cm to about 32 dynes/cm.

16. The surface tension formed lenticular lens material of claim 13, wherein the transparent substrate sheet comprises plastic.

17. The surface tension formed lenticular lens material of claim 14, wherein the plastic is selected from the group consisting of polyester, polyethylene, polypropylene, vinyl, polyethylene terephthalate, polystyrene, poly(methyl methacrylate), polycarbonate, and mixtures thereof.

18. The surface tension formed lenticular lens material of claim 13, wherein the lenticular lens structure ranges in thickness from about 1 micron to about 20 microns.

19. The surface tension formed lenticular lens material of claim 18, wherein the lenticular lens structure has a thickness from about 5 microns to about 10 microns.

20. A surface tension formed lenticular lens material comprising:
(a) a transparent substrate sheet having a front and a back;
(b) an array of substantially parallel lines in at least one energy-curable ink on the front of the sheet; and
(c) at least one energy-curable coating over the array printed in energy-curable ink, the ink and coating being chosen so that sufficient repulsion is created on contact between the ink and the coating to form an aligned series of contiguous beads of coating material before curing takes over to ensure the formation of a lenticular lens structure over the image printed in energy-curable ink.

21. The method of claim 1 wherein the array of substantially parallel lines is printed on the front of the sheet using offset printing.

22. The method of claim 1 wherein the array of substantially parallel lines is printed on the front of the sheet using inkjet printing.
